(19) United States
(12) Patent Application Publication
(10) Pub. No.: US 2017/0221098 A1
(43) Pub. Date: Aug. 3, 2017

(54) METHOD AND SERVER FOR PROMOTING SALES IN A BRICK-AND-MORTAR STORE

(71) Applicants: Chien-Hua Tsao, Taipei City (TW); Ta-Wei Tsao, Taipei City (TW); Steven Tsao, Taipei City (TW)

(72) Inventors: Chien-Hua Tsao, Taipei City (TW); Ta-Wei Tsao, Taipei City (TW); Steven Tsao, Taipei City (TW)

(21) Appl. No.: 15/413,314

(22) Filed: Jan. 23, 2017

(30) Foreign Application Priority Data
Feb. 2, 2016 (TW) 105103223

(51) Int. Cl. G06Q 30/02; H04W 4/02; G06Q 30/06

(52) U.S. Cl. CPC G06Q 30/0259; G06Q 30/0226; G06Q 30/0635; G06Q 30/0255; G06Q 30/0261; G06Q 30/0267; H04W 4/02

(57) ABSTRACT

A method is implemented by a server communicating with a user-end portable device carried by a user. The method includes: receiving from the user-end portable device information that indicates a user-end location of the user-end portable device; calculating a distance between the user-end location and a store location of the brick-and-mortar store; determining an advertised article that is sold in the brick-and-mortar store, according to at least one of a purchase record or a wish associated with the user; and when the distance is smaller than a pre-determined distance, transmitting data to the user-end portable device to enable the user-end portable device to display of a webpage for purchasing the advertised article.

### CROSS-REFERENCE TO RELATED APPLICATION

This application claims priority of Taiwanese Patent Application No. 105103223, filed on Feb. 2, 2016.

### FIELD

The disclosure relates to a method and a server for promoting sales in a brick-and-mortar store.

### BACKGROUND

Electronic commerce (E-commerce) has become increasingly popular partially due to the convenience of shopping and making payments online. As a result, an annual volume of online shopping transactions grows each year.

In view of the popularity of E-commerce, traditional brick-and-mortar stores are in the predicament of having declining sales and profit. It is there desirable for the brick-and-mortar stores to employ a more efficient way of promoting commercial articles sold therein, in order to encourage consumers to visit and make in-store purchases.

### SUMMARY

One object of the disclosure is to provide a method that can implement promotion of sales in a brick-and-mortar store.

According to one embodiment of the disclosure, the method is implemented by a server that is capable of communicating over a network with a user-end portable device carried by a user. The method includes steps of:

receiving from the user-end portable device location information that indicates a user-end location of the user-end portable device;

calculating a distance between the user-end location of the user-end portable device and a store location of the brick-and-mortar store, according to the location information;

determining an advertised article that is sold in the brick-and-mortar store, according to at least one of a purchase record or a wish list that are associated with the user and that are pre-stored in the server; and

when the distance calculated in step b) is smaller than a pre-determined distance, transmitting data to the user-end portable device to enable the user-end portable device to display a webpage for purchasing the advertised article from the brick-and-mortar store.

Another object of the disclosure is to provide a server that is capable of performing the above-mentioned method.

According to one embodiment of the disclosure, the server includes a communication module, a storage device and a processor.

The communication module is capable of communicating over a network with a user-end portable device carried by a user.

The storage device stores a store location of the brick-and-mortar store, article data regarding multiple articles sold in the brick-and-mortar store, and a purchase record and a wish list that are associated with the user.

The processor that is programmed to:

receive, via the communication module from the user-end portable device, location information that indicates a user-end location of the user-end portable device;

calculate a distance between the user-end location of the user-end portable device and a store location of the brick-and-mortar store according to the location information;

determine an advertised article that is sold in the brick-and-mortar store, according to the article data and at least one of the purchase record or the wish list; and

transmit data to the user-end portable device to enable the user-end portable device to display a webpage for purchasing the advertised article from the brick-and-mortar store when it is determined that the distance is smaller than a pre-determined distance.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a system according to one embodiment of the disclosure; and

FIG. 2 and FIG. 3 cooperatively form a flow chart illustrating steps of a method for promotion of sales in a brick-and-mortar store.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

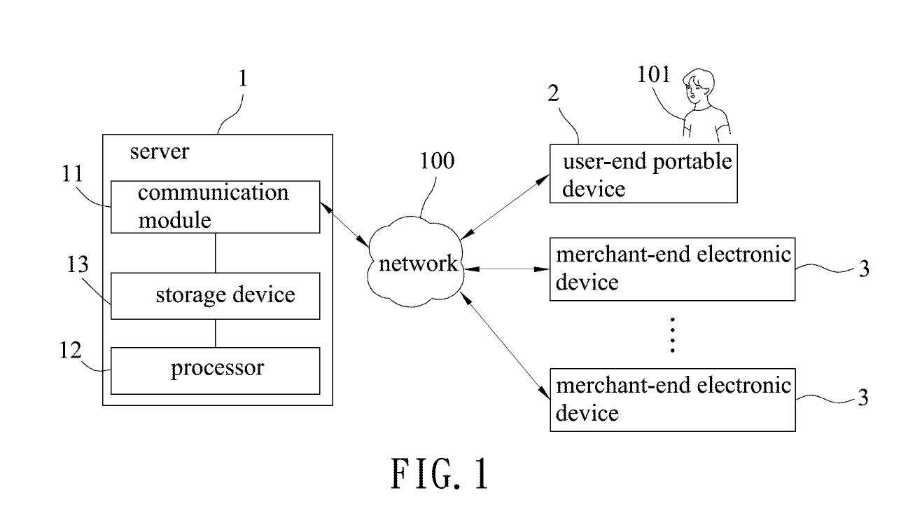

FIG. 1 is a block diagram illustrating a system according to one embodiment of the disclosure. The system includes a server 1 and a user-end portable device 2.

The server 1 includes a communication module 11, a storage device 12 and a processor 13. The communication module 11 enables communication with the user-end portable device 2 and a plurality of merchant-end electronic devices 3 over a network 100 (e.g., the Internet). The merchant-end electronic devices 3 are associated with a number of brick-and-mortar stores, respectively. In some embodiments, the merchant-end electronic devices 3 are located in the brick-and-mortar stores, respectively. The storage device 12 may be embodied using a physical storing device (e.g., hard disk), and may store article data regarding multiple commercial articles sold in each of the brick-and-mortar stores, a number of store locations respectively of the brick-and-mortar stores, a number of promotion locations respectively of a number or promotion spots that are associated respectively with the brick-and-mortar stores, and data regarding a number of users. For example, for each brick-and-mortar store, each corresponding promotion spot is selected by a manager of the brick-and-mortar store, is nearby the brick-and-mortar store, and may have a relatively large number of people passing by or through.

The user-end portable device 2 is carried by a user 101, may be embodied using a smartphone or the like, and includes a camera and a positioning device (e.g., a global positioning system (GPS) device). By operating the positioning device, a user-end location of the user-end portable device 2 may be obtained in the form of a set of coordinates in a geographic coordinate system.

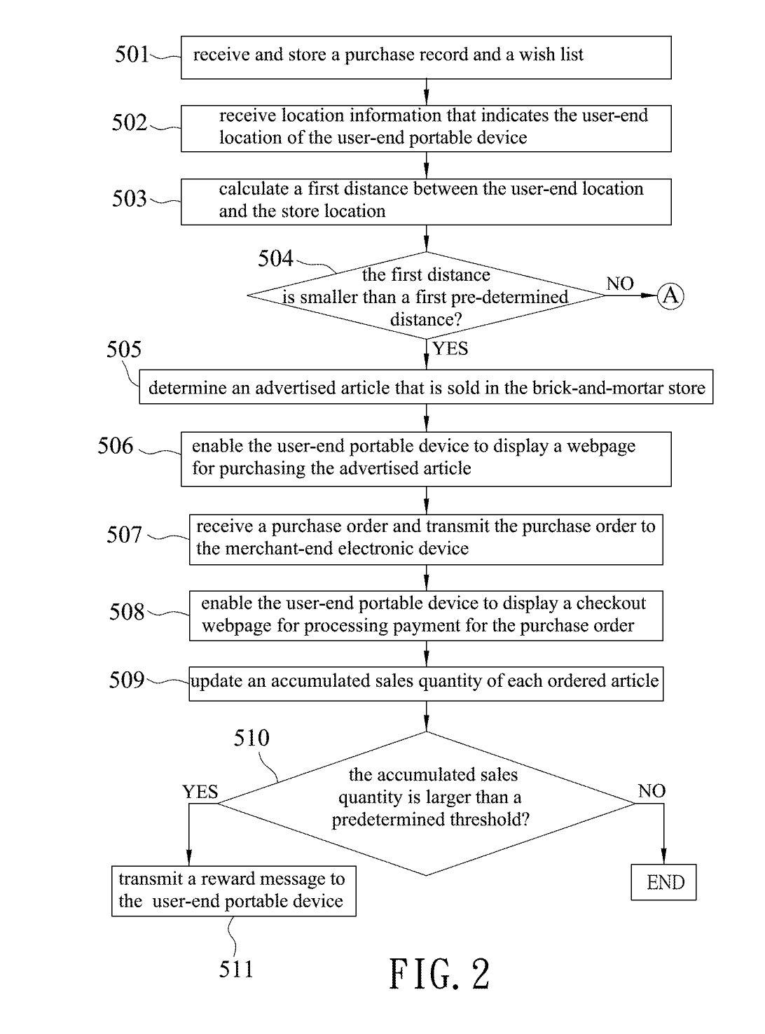

Further referring to FIG. 2, a flow chart illustrates steps of a method for promotion of sales in one of the brick-and-mortar stores.

In step 501, the processor 13 receives a purchase record and a wish list associated with the user 101 from the user-end portable device 2, and stores the purchase record and the wish list into the storage device 12.

Specifically, the purchase record may include a list of commercial articles that the user 101 had purchased. Such a list may be provided by the user (e .g., by way of scanning a Quick Response code on an invoice) or automatically created and added whenever a purchase is made by the user 101. For example, when an online purchase is made by the user 101, the processor 13 may accordingly add the commercial articles) included in the online purchase to the purchase record associated with the user 101. In some embodiments, the purchase record may be manually inputted by the user 101 operating the user-end portable device 2.

The wish list may include a list of commercial articles that the user 101 intends to purchase, and may be provided by the user 101, or generated by the processor 13 based on, for example, the purchase record. For example, the wish list may be manually inputted by the user 101 operating the user-end portable device

In step 502, the processor 13 receives, from the user-end portable device 2 via the communication module 11, location information that indicates the user-end location of the user-end portable device 2.

Specifically, the user-end portable device 2 may activate the positioning device to obtain a set of coordinates associated with the user-end location, and transmit the set of coordinates, serving as the location information, to the server 1. The transmission of information may be done using, for example, a communication unit (not depicted in the drawings) built in the user-end portable device 2, and over the network 100. Additionally, the user 101 of the user-end portable device 2 may operate the camera to capture an image containing a specific icon that is related to the user-end location (e.g., a recognizable landmark, a logo a specific building, a signboard of a brick-and-mortar store, etc.), embed the location information in the image, and transmit the image along with the location information (i.e., the set of coordinates) to the server 1.

In response to receipt of the location information, in step 503, the processor 13 calculates a first distance between the user-end location of the user-end portable device 2 and the store location of each of the brick-and-mortar stores according to the location information. Specifically, the processor 13 retrieves the store location of each of the brick-and-mortar stores from the storage device 12, and calculates the first distance accordingly.

In step 504, the processor 13 determines whether the first distance between the user-end location and the store location of one of the brick-and-mortar stores is smaller than a first pre-determined distance . When it is determined that first distance is smaller than the first pre-determined distance, the flow proceeds to step 505. Otherwise, the step proceeds to step 512. It should be noted that only one of the brick-and-mortar stores that is away from the user-end location by a distance shorter than the first pre-determined distance and the corresponding one of the merchant-end electronic devices 3 are described in the following description of steps 505-512 for the sake of brevity.

In step 505, the processor 13 determines an advertised article that is sold in the brick-and-mortar store, according to the article data stored in the storage device 12 and at least one of the purchase record or the wish list associated with the user 101.

Specifically, the processor 13 selects as the advertised article, according to the article data stored in the storage device 12, one of the commercial articles that is sold in the brick-and-mortar store and that is included in at least one of the purchase record or the wish list. In other embodiments, the processor 13 may be programmed to determine a commercial article that may be interested by the user 101 as the advertised article according to the purchase record or the wish list. For example, the processor 13 may determine a consumable product used for a commercial article in the purchase record, or a congeneric article similar to a commercial article in the purchase record or the wish list as the advertised article.

In step 506, the processor 13 transmits data to the user-end portable device 2, so as to enable the user-end portable device 2 to display a webpage for purchasing the advertised article from the brick-and-mortar store. The webpage may include a token for claiming a gift or a virtual coupon that allows the user to purchase the advertised article at a reduced price and/or with additional discounts with purchase of one or more other commercial article (s) it is noted that the webpage may further allow the user to purchase other articles from the brick-and-mortar store, and this disclosure is not limited thereto.

Afterward, upon deciding to purchase an article from the brick-and-mortar store on the webpage, the user 101 may operate the user-end portable device 2 to input a purchase order for the desired article (s). The purchase order includes a quantity of each article which the user 101 intends to purchase (hereinafter referred to as “ordered article”).

In step 507, the processor 13 receives the purchase order from the user-end portable device 2, and in response, the processor 13 transmits the purchase order to the merchant-end electronic device 3, and requests a processing time associated with the purchase order from the merchant-end electronic device 3. Specifically, the processing time indicates the time required for preparing the ordered article(s) ordered by the user 101. After the processing time, the user 101 may go to the brick-and-mortar store to retrieve the ordered article(s).

Upon receipt of the purchase order, the merchant-end electronic device 3 determines the processing time, and transmits the processing time to the server 1. The processing time may be determined according to the quantity of each ordered article(s) in the purchase order, and a product type of each ordered article. For example, when the user 101 uses the user-end portable device 2 to submit a purchase order for ten cups of coffee, and assuming that the time for preparing one cup of coffee is 2 minutes, then the merchant-end electronic device 3 may determine the processing time to be 20 minutes by multiplying the unit time (2 minutes) by the quantity of the ordered article (i.e., 10).

In step 508, upon receipt of the processing time, the processor 13 transmits data to the user-end portable device 2 to enable the user-end portable device 2 to display a checkout webpage for processing payment for the purchase order. In some embodiments, the checkout webpage includes the processing time.

In this embodiment, the user 101 may operate the user-end portable device 2 to communicate with a bank terminal (not depicted in the drawings) in association with the brick-and-mortar store for proceeding with the payment by money transfer or by use of a credit card. After receiving the payment, the bank terminal transmits a notification to the server 1 indicating that the payment has been completed. Since generation and transmission of the notification are well-known in the art, details thereof will be omitted herein for the sake of brevity.

It is noted that in some embodiments, the payment is processed without involvement of the bank terminal. For example, the payment may be completed when the user goes to the brick-and-mortar store at retrieving the ordered article(s).

In one example, the user-end portable device 2 may be provided with a digital wallet and may be capable of communicating with the merchant-end electronic device 3 using, for example, near field communication (NEC) to proceed with the payment by the digital wallet, and then, the merchant-end electronic device 3 may generate the notification and transmit the same to the server 1. In another example, the user 101 may make the payment in person (e.g., by cash), and then a clerk at the brick-and-mortar store may operate the merchant-end electronic device 3 to generate and transmit the notification.

In step 509, the processor 13 of the server 1 updates an accumulated sales quantity of each ordered article in a sales record stored in the storage device 12. In this embodiment, the sales record is associated with the brick-and-mortar store at which the purchase takes place. In other embodiments, the sales record may be associated jointly with a plurality of brick-and-mortar stores (e.g., a number of stores under a particular retail chain).

The accumulated sales quantity of each article is a total quantity of the article that has been sold at the brick-and-mortar store (including purchases made through the webpage). In one embodiment, the sales record is directed to the user 101 (or the user-end portable device 2) in particular and the accumulated sales number therein indicates a total quantity of the corresponding article that the user 101 has already purchased. In some embodiments, whenever any user (not limited to a particular single user) places an order on an article, an ordered quantity of that article is added to the accumulated sales number of that article in the sales record. In this case, the sales record is not directed to any user (or the user-end portable device) in particular. For example, when two separate purchase orders for 10 units and 20 units of a specific article are received by the server 1, the processor 13 updates the accumulated sales quantity of the specific article by adding a total of 30 units thereto.

In some embodiments, after step 509, the flow may further proceed to step 510, in which the processor 13 determines whether the accumulated sales quantity of any article is larger than a predetermined threshold. It is noted that the accumulated sales quantity may be reset before a particular time period (e.g., a limited sales period during which a more favorable deal is offered).

In the case where the sales record is directed to the user 101 (or the user-end portable device 2) , when it is determined that the accumulated sales quantity of any article is larger than the predetermined threshold, the flow proceeds to step 511, in which the processor 13 transmits a reward message to the user-end portable device 2 for providing a reward. Otherwise, the method is terminated without transmitting the reward message. For example, the reward message is transmitted using a text message, an email, etc.

In some embodiments where the accumulated sales quantity is accumulated whenever any user purchases the ordered article, the processor 13 may identify the user(s) who has purchased the ordered article (i.e., “contributed” to the accumulated sales quantity being over the predetermined threshold) and transmit the reward message to all identified user(s).

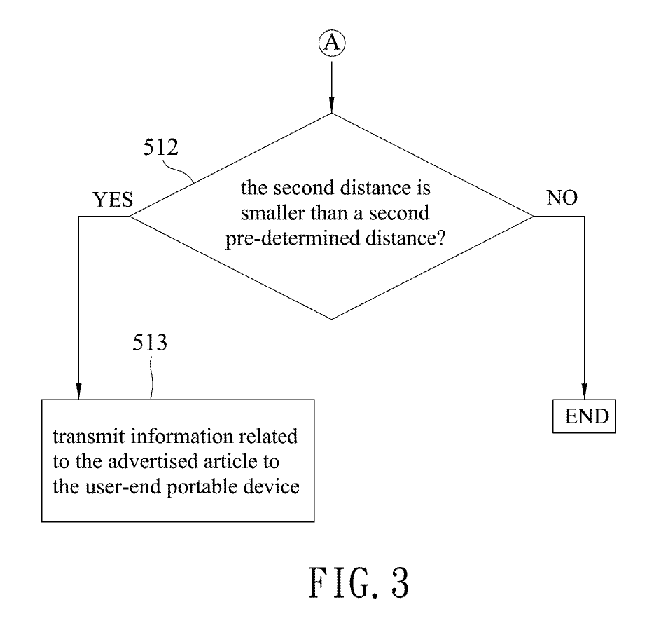

Referring to FIG. 3, when it is determined in step 504 that the first distance is not smaller than the first pre-determined distance, the processor 13 proceeds to step 512 to calculate a second distance between the user-end location of the user-end portable device 2 and a promotion location of a nearest one of the promotion spots that is associated with the brick-and-mortar store.

When it is determined that the second distance is smaller than a second pre-determined distance, the processor 13 transmits information related to the advertised article and the brick-and-mortar store to the user-end portable device 2. Otherwise, the method is terminated without transmitting said information. The information may include product information of the advertised article, an address of the brick-and-mortar store, and/or a special deal on the advertised article when purchased in-store, etc.

The above steps may be implemented to act as a replacement of hiring additional manpower to promote the commercial articles sold in the brick-and-mortar store (e.g., by manually distributing leaflets) at a particular location.

In one embodiment, two or more of the brick-and-mortar stores may collaborate to present another form of promotion. For example, in step 506, the processor 13 may transmit additional data to the user-end portable device 2 such that the webpage displayed by the user-end portable device 2 includes a notification informing the user 101 that a reward will be offered once the user 101 visits or makes a purchase in each of the two or more brick-and-mortar stores. In such a case, the user 101 of the user-end portable device 2 may operate the camera to capture an image at each of the two or more brick-and-mortar stores, and upload the two or more images to the server 1 in order to claim the reward.

To sum up, the method and system as described in the disclosure provides a way for the brick-and-mortar stores to promote the commercial articles that are being sold therein to users that are in a nearby location. After a purchase order is placed, the user may be informed of the processing time required by the brick-and-mortar store receiving the purchase order, and retrieve the ordered article (s) when available at the brick-and-mortar store, without having to wait at the brick-and-mortar store. Additionally, in implementing the method, various rewards may be offered to the user in return for the user visiting and/or making purchase (s) in the brick-and-mortar store (s). As a result, the user may have more incentive to visit the brick-and-mortar store(s) in person instead of shopping online.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for promoting sales in a brick-and-mortar store, the method to be implemented by a server that is capable of communicating over a network with a user-end portable device carried by a user, the method comprising steps of:
a) receiving, from the user-end portable device, location information that indicates a user-end location of the user-end portable device;
b) calculating a first distance between the user-end location of the user-end portable device and a store location of the brick-and-mortar store according to the location information;
c) determining an advertised article that is sold in the brick-and-mortar store, according to at least one of a purchase record or a wish list that are associated with the user and that are pre-stored in the server; and
d) when the first distance calculated in step b) is smaller than a first pre-determined distance, transmitting data to the user-end portable device to enable the user-end portable device to display a webpage for purchasing the advertised article from the brick-and-mortar store.

2. The method of claim 1, further comprising after step b), steps of:
when the first distance is not smaller than the first pre-determined distance, calculating a second distance between the user-end location of the user-end portable device and a promotion location of a promotion spot that is associated with the brick-and-mortar store;
when the second distance is smaller than a second pre-determined distance, transmitting information related to the advertised article to the user-end portable device.

3. The method of claim 1, further comprising, prior to step a), a step of receiving the purchase record and the wish list associated with the user from the user-end portable device.

4. The method of claim 1, wherein the location information of the user-end portable device is embedded in an image that is related to the user-end location and that is captured by the user-end portable device.

5. The method of claim 1, wherein the location information of the user-end portable device is obtained by a positioning module of the user-end portable device.

6. The method of claim 1, the server being further capable of communicating over a network with a merchant-end electronic device, the method further comprising, after step d), steps of:
receiving a purchase order for at least one ordered article from the user-end portable device;
transmitting the purchase order to the merchant-end electronic device, and requesting a processing time associated with the purchase order from the merchant-end electronic device; and
upon receipt of the processing time, transmitting data to the user-end portable device to enable the user-end portable device to display a checkout webpage for processing payment for the purchase order, the checkout webpage including the processing time.

7. The method of claim 6, further comprising steps of:
after the payment completed, updating an accumulated sales quantity of the ordered article that has been sold by the brick-and-mortar store based on an ordered quantity of the ordered article in the purchase order;
determining whether the accumulated sales quantity is larger than a predetermined threshold; and
when it is determined that the accumulated sales quantity is larger than a predetermined threshold, transmitting a reward message to the user-end portable device for providing a reward.

8. The method of claim 7, wherein the accumulated sales quantity is updated by adding the ordered quantity of the ordered article in the purchase order to the accumulated sales quantity of the ordered article stored in the server.

9. A server for promoting sales in a brick-and-mortar store, said server comprising:
a communication module that is capable of communicating over a network with a user-end portable device carried by a user;
a storage device storing a store location of the brick-and-mortar store, article data regarding multiple articles sold in the brick-and-mortar store, and a purchase record and a wish list that are associated with the user; and
a processor that is programmed to:
receive, via said communication module from the user-end portable device, location information that indicates a user-end location of the user-end portable device;
calculate a first distance between the user-end location of the user-end portable device and the store location of the brick-and-mortar store according to the location information;
determine an advertised article that is sold in the brick-and-mortar store, according to the article data and at least one of the purchase record or the wish list; and
transmit data to the user-end portable device via said communication module to enable the user-end portable device to display a webpage for purchasing the advertised article from the brick-and-mortar store when it is determined that the first distance is smaller than a first pre-determined distance.

10. The server of claim 9, wherein said processor is further programmed to:
calculate a second distance between the user-end location of the user-end portable device and a promotion location of a promotion spot that is associated with the brick-and-mortar store when the first distance is not smaller than the first pre-determined distance; and
transmit information related to the advertised article to the user-end portable device when the second distance is smaller than a second pre-determined distance.

11. The server of claim 9, wherein said communication module receives the purchase record and the wish list associated with the user from the user-end portable device.

12. The server of claim 9, wherein said communication module is capable of communicating over a network with a merchant-end electronic device, and said processor is further programmed to:
receive a purchase order for at least one ordered article from the user-end portable device;
transmit the purchase order to the merchant-end electronic device, and request a processing time associated with the purchase order from the merchant-end electronic device; and
upon receipt of the processing time, transmit data to the user-end portable device to enable the user-end portable to display a checkout webpage for processing payment for the purchase order, the checkout webpage including the processing time.

13. The server of claim 12, wherein said processor is further programmed to:
after the payment is completed, update an accumulated sales quantity of the ordered article that has been sold based on an ordered quantity of the ordered article in the purchase order;
determine whether the accumulated sales quantity is larger than a predetermined threshold; and
when it is determined that the accumulated sales quantity is larger than a predetermined threshold, transmit a reward message to the user-end portable device for providing a reward.

14. The server of claim 12, wherein the accumulated sales quantity is updated by adding the ordered quantity of the ordered article in the purchase order to the accumulated sales quantity of the ordered article stored in said storage device.
